(19) United States
(12) Patent Application Publication
(10) Pub. No.: US 2025/0219107 A1
(43) Pub. Date: Jul. 3, 2025

(54) FUEL CELL INCLUDING GRAPHYNE-BASED MATERIAL

(71) Applicant: Robert Bosch GmbH, Stuttgart (DE)

(72) Inventors: Sergei CHUMAKOV, Palo Alto, CA (US); Daniil KITCHAEV, Brookline, MA (US); Jonathan Braaten, Sunnyvale, CA (US); Shirin Mehrazi, Sunnyvale, CA (US); Bjoern Stuehmeier, Santa Clara, CA (US); Lei Cheng, Sunnyvale, CA (US); Jake Christensen, Elk Grove, CA (US)

(21) Appl. No.: 18/401,050

(22) Filed: Dec. 29, 2023

(51) Int. Cl. H01M 8/0213; H01M 8/10; H01M 8/1004

(52) U.S. Cl. CPC H01M 8/0213; H01M 8/1004; H01M 2008/1095

(57) ABSTRACT

A fuel cell includes an anode catalyst layer, a cathode catalyst layer, an electrolyte membrane layer extending between the anode catalyst layer and the cathode catalyst layer, and a graphyne-based layer. The graphyne-based layer disposed between the cathode catalyst layer and the electrolyte membrane layer or the anode catalyst layer and the electrolyte membrane layer, the graphyne-based layer is configured to suppress crossover gases to enhance performance of the fuel cell. The anode catalyst layer configured to facilitate an electrochemical reaction converting a gaseous hydrogen atom to a proton and an electron.

### TECHNICAL FIELD

The present disclosure relates to a fuel cell including a graphyne-based material.

### BACKGROUND

Fuel cells have shown promise as an alternative power source for vehicles and other transportation applications. Fuel cells operate with a renewable energy carrier, such as hydrogen. Fuel cells also operate without toxic emissions or greenhouse gases. An individual fuel cell includes a membrane electrode assembly (MEA) and two flow field plates. An individual fuel cell typically delivers 0.3 to 1.0 V. Individual fuel cells can be stacked together to form a fuel cell stack having higher voltage and power.

One of the current limitations of widespread adoption and use of this clean and sustainable technology is the relatively expensive cost of fuel cells. A catalyst material (e.g., platinum catalyst) is included in both the anode and cathode catalyst layers of a fuel cell. The catalyst material is one of the most expensive components in the fuel cell.

Fuel cells are susceptible to degradation—a decrease the cell performance over time. One of the central degradation mechanisms is redistribution of catalyst particles in a polymer, thus decreasing the number of available sites for catalytic reaction, which happens on the surface of catalyst. Prevention of particle migration could prolong the life of the fuel cell and thus lower the overall energy cost.

### SUMMARY

According to one embodiment, a fuel cell includes an anode catalyst layer, a cathode catalyst layer, an electrolyte membrane layer extending between the anode catalyst layer and the cathode catalyst layer, and a graphyne-based layer. The graphyne-based layer is disposed between the cathode catalyst layer and the electrolyte membrane layer or the anode catalyst layer and the electrolyte membrane layer, the graphyne-based layer is configured to suppress crossover gases to enhance performance of the fuel cell. The anode catalyst layer configured to facilitate an electrochemical reaction converting a gaseous hydrogen atom to a proton and an electron.

In another embodiment, a fuel cell includes an anode catalyst layer, a cathode catalyst layer, an electrolyte membrane layer extending between the anode catalyst layer and the cathode catalyst layer, and a graphyne-based layer. The anode catalyst layer is configured to facilitate an electrochemical reaction converting a gaseous hydrogen atom to a proton and an electron. The graphyne-based layer is disposed between the cathode catalyst layer and the electrolyte membrane layer and/or the anode catalyst layer and the electrolyte membrane layer. The graphyne-based layer is separate and discrete from the anode catalyst layer, the cathode catalyst layer, and the electrolyte membrane layer. The graphyne-based layer is configured to suppress crossover gases to enhance performance of the fuel cell.

In yet another embodiment, a fuel cell includes and anode catalyst layer, a cathode catalyst layer, an electrolyte membrane layer extending between the anode catalyst layer and the cathode catalyst layer; and a graphyne-based layer. The anode catalyst layer is configured to facilitate an electrochemical reaction converting a gaseous hydrogen atom to a proton and an electron. The graphyne-based layer is disposed between the cathode catalyst layer and the electrolyte membrane layer and/or the anode catalyst layer and the electrolyte membrane layer. The graphyne-based layer includes first regions of single layer graphyne flakes and second regions of stacks of multi-layer graphyne flakes. The graphyne-based layer is configured to suppress crossover gases to enhance performance of the fuel cell.

### BRIEF DESCRIPTION OF THE DRAWINGS

FIG. 1 depicts a schematic, side view of a fuel cell.

FIG. 2A depicts a top view of a graphyne-based layer including graphyne-based sublayers according to one embodiment.

FIG. 2B depicts a side view of a graphyne-based layer including graphyne-based sublayers according to one embodiment.

FIG. 2C is a 2D chemical structure illustration of a part of a single molecule of gamma-graphyne.

FIG. 2D is a 2D chemical structure illustration of three layers of gamma-graphyne stacked in ABC-stacking.

FIG. 2E depicts a multi-layer gamma-graphyne flake as observed via lateral force microscopy (LFM).

FIG. 2F is a graphical representation of energy with respect to reaction coordinates illustrating the energy required to hold a molecule of hydrogen gas at various locations along the line perpendicular to the plane of ABC-stacked gamma-graphyne.

FIG. 2G is a 2D chemical structure illustration of three layers of gamma-graphyne stacked in ABC-stacking illustrating a location a hydrogen molecule may passes through one of the benzene rings.

FIG. 3A depicts a schematic, side view of an MEA having a graphyne-based layer at an interface between a cathode catalyst layer and an electrolyte membrane layer.

FIG. 3B depicts a schematic, side view of an MEA having first and second graphyne-based layers at an interface between a cathode catalyst layer and an electrolyte membrane layer and an interface between an anode catalyst layer and an electrolyte membrane layer.

FIGS. 4A through 4E present examples of graphynes: α-graphyne (FIG. 4A), β-graphyne (FIG. 4B), γ-graphyne (FIG. 4C), graphdiyne (FIG. 4D) and 6,6,12-graphyne (FIG. 4E).

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary:percent, “parts of,” and ratio values are by weight; the term “polymer” includes “oligomer,” “ionomer,” “copolymer,” “terpolymer,” and the like; the term “graphyne” includes all members of the graphyne family; the description of a group or class of materials as suitable or preferred for a given purpose in connection with the invention implies that mixtures of any two or more of the members of the group or class are equally suitable or preferred; molecular weights provided for any polymers refers to number average molecular weight; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

This invention is not limited to the specific embodiments and methods described below, as specific components and/or conditions may, of course, vary. Furthermore, the terminology used herein is used only for the purpose of describing embodiments of the present invention and is not intended to be limiting in any way.

As used in the specification and the appended claims, the singular form “a,” “an,” and “the” comprise plural referents unless the context clearly indicates otherwise. For example, reference to a component in the singular is intended to comprise a plurality of components.

The term “substantially” may be used herein to describe disclosed or claimed embodiments. The term “substantially” may modify a value or relative characteristic disclosed or claimed in the present disclosure. In such instances, “substantially” may signify that the value or relative characteristic it modifies is within +0%, 0.1%, 0.5%, 1%, 2%, 3%, 4%, 5% or 10% of the value or relative characteristic.

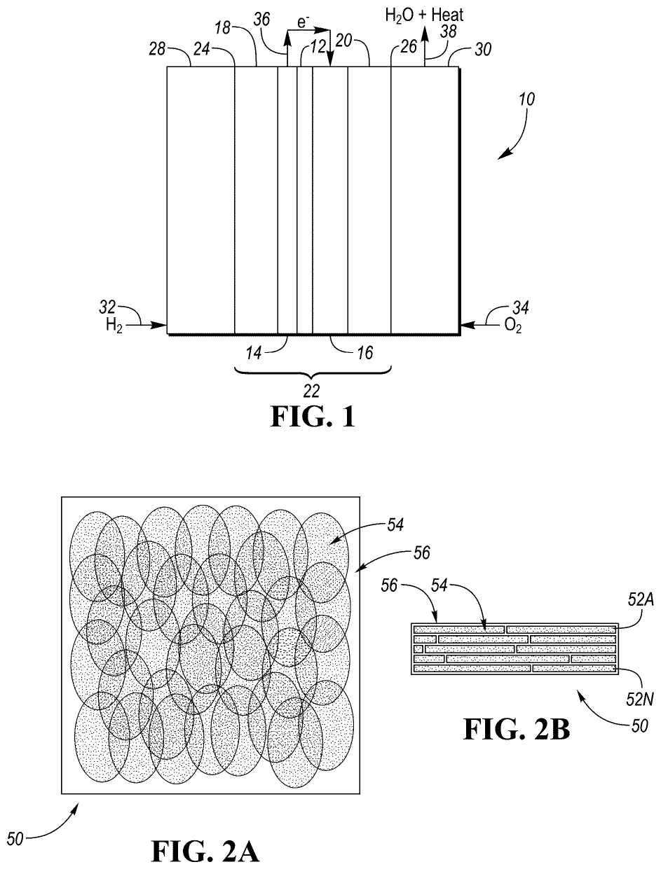

Proton-exchange membrane fuel cell (PEMFC) technology has been commercialized for fuel cell vehicle applications. FIG. 1 depicts a schematic, side view of fuel cell 10. Fuel cell 10 can be stacked to create a fuel cell stack. Fuel cell 10 includes polymer electrolyte membrane (PEM) 12, anode 14, cathode 16 and first and second gas diffusion layers (GDLs) 18 and 20. PEM 12 is situated between anode 14 and cathode 16. Anode 14 is situated between first GDL 18 and PEM 12 and cathode 16 is situated between second GDL 20 and PEM 12. PEM 12, anode 14, cathode 16 and first and second GDLs 18 and 20 comprise membrane electrode assembly (MEA) 22. First and second sides 24 and 26 of MEA 22 is bounded by flow fields 28 and 30, respectively. Flow field 28 supplies H₂ to MEA 22, as signified by arrow 32. Flow field 30 supplies O₂ to MEA 22, as signified by arrow 34. A catalyst material, such as platinum, is used in anode 14 and cathode 16. The catalyst material is commonly the most expensive constituent of MEA 22. Non-limiting examples of catalysts are noble metals such as platinum (Pt), palladium (Pd), or Iridium (Ir), and alloys thereof (e.g., Pt alloys), or their combination, as well as non-noble catalysts like doped carbons.

The anode performs the hydrogen oxidation reaction (HOR) (1) while the cathode performs the oxygen reduction reaction (ORR) (2):

H₂→2H⁺+2e^{-s} (1)

4H⁺+O₂+4e⁻→2H₂O (2)

Generally, the H₂ is broken down on the surface of the electrocatalyst in the anode to form protons and electrons in a HOR. The electrons are transported through the support of the anode catalyst layer to the external circuit while the protons are pulled through the proton exchange membrane to the cathode catalyst layer. Once in the cathode catalyst layer, the protons move through the ion-conducting polymer or ionomer thin-film network to the electrocatalyst surface, where they combine with the electrons from the external circuit and the O₂ that has diffused through the pores of the cathode catalyst layer to form water in the ORR.

Electrocatalysts play a crucial role in the fuel cells as they enable the HOR, HER and ORR reactions. Electrocatalysts are typically included in a form of particles. To increase their stability and prevent their loss via dissolution or detachment, the catalysts may be attached to a support. The most frequently used catalysts are noble metals such as platinum (Pt), palladium (Pd), or Iridium (Ir), or their combination, as well as non-noble catalysts like doped carbons. The support may typically include carbon, metals, metal oxides, or their combination.

Electrocatalyst durability in electrochemical processes is a topic of great interest to guarantee stable performance of the electrochemical cells and devices. For example, stability of Pt nanoparticles (NPs) in fuel cells is a major technological challenge for fuel cell commercialization. Pt dissolution is typically observed when fuel cell operation is cycled into oxide formation voltage (e.g, greater than 0.9 Volts).

Carbon-supported platinum is currently the most widely used electrocatalysts in fuel cells and is a major contributor to fuel cost. Despite its maturity and improved performance, lifetime, and stability of fuels are greatly limited by the catalyst corrosion and degradation processes occurring on the surface of the catalyst, resulting in mass loss, structural evolution, and/or reduction in catalytically electrochemical active surface area (ECSA) (e.g., a formation of an electrically disconnected Pt band as described above).

Two key inhibitors to mass-market penetration of proton-exchange membrane fuel cell (PEMFC) vehicles are their high cost due to the platinum used as the catalyst and the degradation of the expensive platinum during voltage cycling. Platinum catalyst degrades during voltage cycling of PEMFCs, causing particle coarsening and deposition in the membrane as an electrically isolated platinum band that can no longer participate in the oxygen reduction reaction (ORR). This loss of active platinum is responsible for hindering efficiency and high-power performance in PEMFC vehicles and is a limitation on PEMFC vehicle lifetime.

For example, gas crossover through the membrane (H₂ from the anode, and O₂ from the cathode) lowers the reversible potential of the cell and contributes to degradation. H₂ crossover from the anode reacts with ionic Pt in the membrane to form the metallic Pt band. O₂ crossover from the cathode reacts in the anode to form peroxides, which then attack the ionomer in the catalyst layer and membrane. Both crossover mechanisms are responsible for additional degradation and are targets for improving performance and lifetime.

There are various hybridization states (sp, sp², sp³) of carbon that allow diverse covalent bonding between carbon atoms and result in numerous carbon allotropes. For example, the two most stable natural carbon allotropes are graphite and diamond, which have sp² and sp³ hybridization characters, respectively. Graphynes are a family of carbon allotropes that have one-atom-thickness and sp and sp² carbon atoms. Graphynes can be constructed by either partially or completely replacing the C—C bonds in graphene with one or more acetylenic groups —C≡C—.

The structure of graphynes can be visualized as a 2D network. The elements of this network are hexagonal carbon rings (benzene rings, sp²-hybridized) and/or single carbon atoms. The elements of this network are connected by acetylenic linkages. The length of acetylene linkages can be different, leading to the graphyne-n structures, in which n indicates the number of acetylene bridges (—C≡C—) in the linkage.

Graphynes and functionalized versions thereof are materials capable of suppressing diffusion of large cations like Pt²⁺ and gaseous species, i.e., O₂ and H₂, and being highly permeable to protons. These qualities make graphyne-based functional layers well-suited for functional layers designed to prevent Pt²⁺ and other cation redistribution and prevent/mitigate reactant gas crossover, while maintaining proton conductivity for PEMFC performance.

One or more embodiments disclose a graphyne-based (e.g., graphyne or doped graphyne) functional layer and its fabrication and integration within MEAs. In one embodiment, the graphyne-based functional layer includes layers of graphyne-based material. The graphyne-based material may be a graphyne material, a doped graphyne or graphyne oxide material, or a combination thereof. For instance, the graphyne-based material may be a graphdiyne material subjected to heteroatom doping (e.g., N, S, F, and/or Cl). As another example, the graphyne-based material may be a graphdiyne material doped with one or more transitional metals (e.g., Cu, Pd, Ni, and/or Fe). The graphyne-base material layers may include individual layers of flakes bound together by an ionomer material. In one or more embodiments, graphyne flakes may be structured as anchors for catalyst particles (e.g., Pt/Ir particles) in and/or on catalytic layers. In one or more embodiments, graphene-based material may be mixed with a catalyst layer ink.

In one or more embodiments, a selectively permeable graphyne-based functional layer is utilized to improve the efficiency and durability of proton exchange membrane fuel cells. The functional layer(s) (as described herein) in a PEMFC MEA is configured to suppress the crossover of molecular oxygen and hydrogen for the purpose of enhancing efficiency and preventing degradation from species generated from these crossover gases. In addition, the functional layer(s) are configured to suppress the migration and/or diffusion of degraded cationic species like platinum from the catalyst and alloying elements cobalt and nickel from the de-alloyed interior of the catalyst particles. The functional layer may be configured to enhance both the durability of the MEA as well as improve efficiency and contribute to longer-lasting, higher-performing PEMFC MEAs.

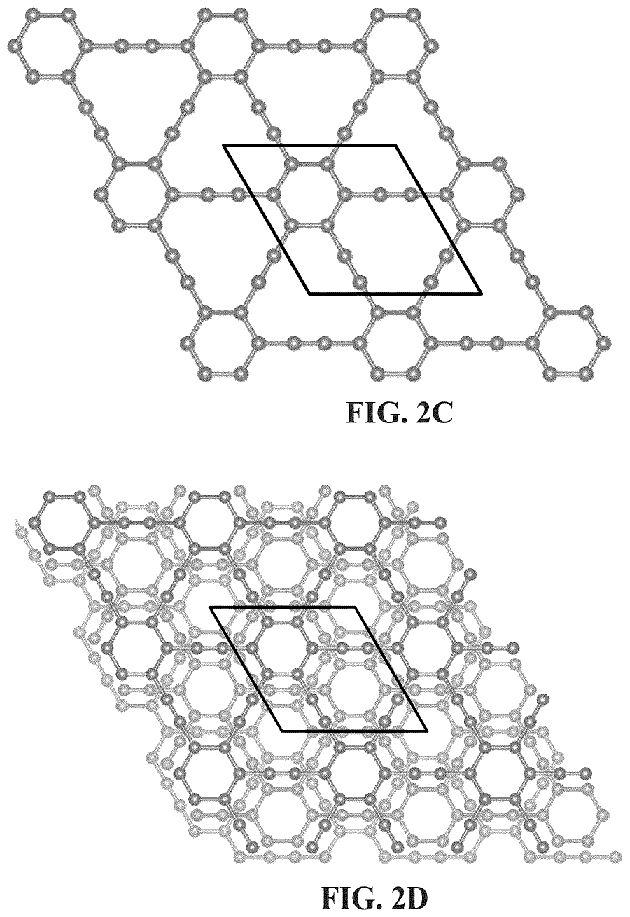

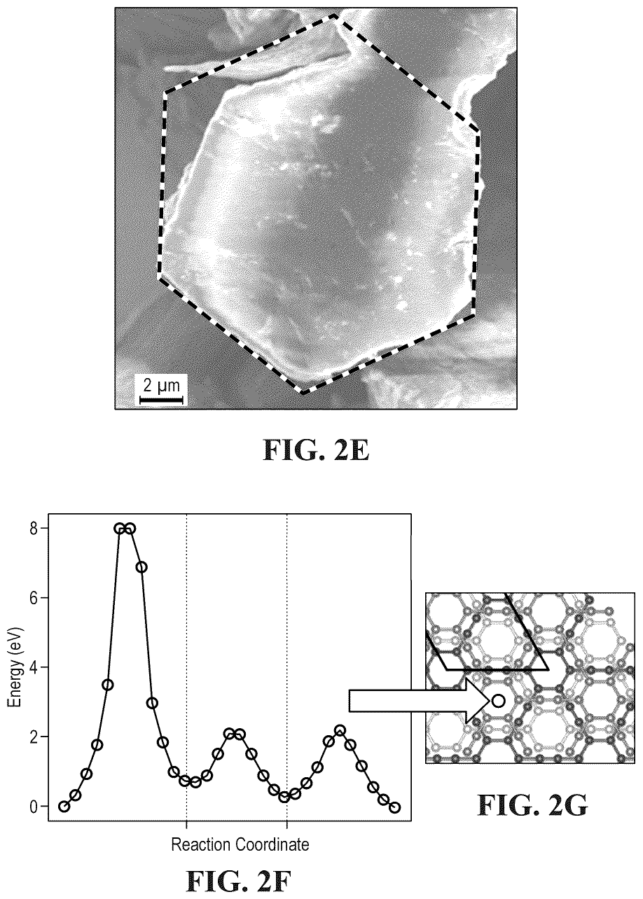

FIG. 2A depicts a top view of graphyne-based layer 50 including graphyne-based sublayers. FIG. 2B depicts a side view of graphyne-based layer 50 including graphyne-based sublayers 52A through 52N. Each of the graphyne-based sublayers is comprised of graphyne-based flakes 54 bound together with polymeric binder 56. Polymeric binder 56 may be an ionomer material. Non-limiting examples of ionomer materials include a Nafion ionomer, a Nafion-based material, a polyfluoropolymer such as polytetrafluoroehtylene (PTFE), a low equivalent weight ionomer, a high oxygen permeable ionomer (HOPI), and a combination thereof. The graphyne-based material may be a graphyne material, a graphyne oxide material, or a combination thereof. The weight ratio of the ionomer material to the graphyne-based material in the graphyne-based layer may be any of the following values or in the range of any two of the following values: 1:10, 2:10, 3:10, 4:10, 5:10, 6:10, 7:10, 8:10, 9:10, 1:1, 1.5:1, 2:1, 2.5:1, 3:1, 3.5:1, 4:1, 4.5:1, 5:1, 6:1, 7:1, 8:1, 9:1, and 10:1. The graphyne-based layer may be a discrete layer from a catalyst layer (e.g., a cathode catalyst layer) and/or membrane layer. The thickness of the graphyne-based layer may be 0.1, 0.2, 0.3, 0.4, 0.5, 0.6, 0.7, 0.8, 0.9, 1.0, 1.5, 2.0, 2.5, 3.0, 3.5, 4.0, 4.5, and 5.0 μm. Alternatively, the graphyne-based layer may be mixed with a catalyst layer (e.g., a cathode catalyst layer) and/or membrane layer.

Graphyne-based flakes can be comprised of single-layer or multi-layer graphyne or combination of thereof. FIG. 2C schematically depicts a single-layer gamma-graphyne and FIG. 2D depicts multi-layer gamma-graphyne, arranged in so-called “ABC” stacking. FIG. 2E depicts a multi-layer gamma-graphyne flake as observed via lateral force microscopy (LFM).

Graphyne can serve as an effective barrier for gases. Results of a computational investigation of permeability of graphyne are shown in the FIG. 2F. FIG. 2G shows an energy that is required from a single molecule of hydrogen in order to pass through three layers of graphyne stacked in the ABC stacking. The results show that the required energy is about 2 eV, which is unachievable under normal conditions, and therefore, graphyne can serve as an effective barrier for gases.

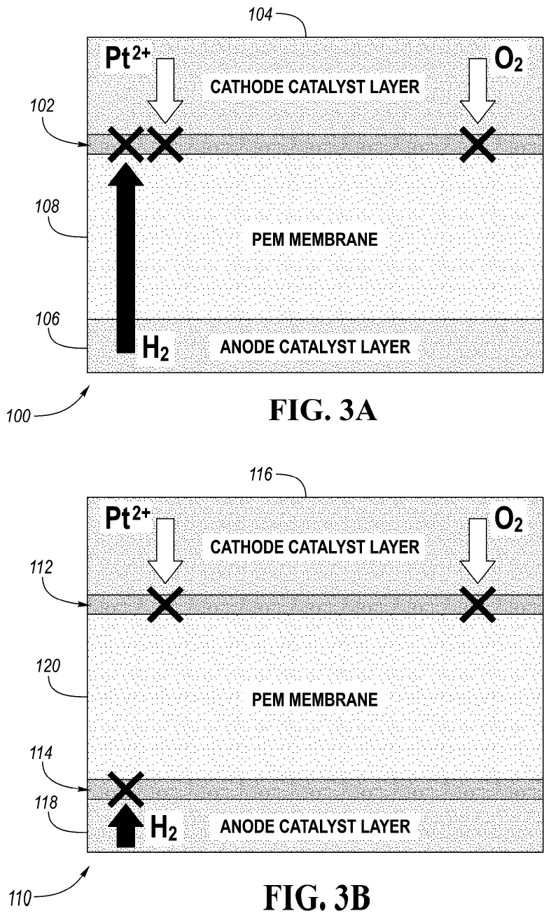

In one embodiment, the graphyne-based layer may be disposed at the interface between a cathode catalyst layer and an electrolyte membrane layer. FIG. 3A depicts a schematic, side view of MEA 100 having graphyne-based layer 102 according to one embodiment. MEA 100 includes cathode catalyst layer 104, anode catalyst layer 106, and electrolyte membrane layer 108 extending between cathode catalyst layer 104 and anode catalyst layer 106. Graphyne-based layer 102 is disposed at the interface of cathode catalyst layer 104 and electrolyte membrane layer 108. Graphyne-based layer 102 may be graphyne-based sublayers where the sublayers are formed of graphyne-based flakes bound by an ionomer material.

Graphyne-based layer 102 is configured to reduce or prevent transport of molecular hydrogen into cathode catalyst layer 104 and molecular oxygen out of cathode catalyst layer 104. Graphyne-based layer 102 is also configured to reduce or prevent transport of catalyst material (e.g., Pt²⁺ catalyst material as shown in FIG. 3A) out of cathode catalyst layer 104. Graphyne-based layer 102 is configured to suppress crossover gases (e.g., hydrogen into cathode catalyst layer 104 and molecular oxygen out of cathode catalyst layer 104). This suppression of crossover gases may improve performance and efficiency of the MEA. Moreover, the suppression may decrease degradation of the MEA by hindering degradation reactants (e.g., O₂ to the anode for peroxide formation and/or H₂ to the cathode for reducing cationic Pt).

In another embodiment, the graphyne-based layer may be disposed at the interface between a cathode catalyst layer and an electrolyte membrane layer and an anode catalyst layer and the electrolyte membrane layer. FIG. 3B depicts a schematic, side view of MEA 110 having graphyne-based layers 112 and 114 according to one embodiment. MEA 110 includes cathode catalyst layer 116, anode catalyst layer 118, and electrolyte membrane layer 120 extending between cathode catalyst layer 116 and anode catalyst layer 118. Graphyne-based layer 112 is disposed at the interface of cathode catalyst layer 116 and electrolyte membrane layer 120. Graphyne-based layer 114 is disposed at the interface of anode catalyst layer 118 and electrolyte membrane layer 120. Graphyne-based layers 112 and 114 may each be graphyne-based sublayers where the sublayers are formed of graphyne-based flakes bound by an ionomer material.

Graphyne-based layers 112 and 114 are configured to reduce or prevent transport of molecular hydrogen into cathode catalyst layer 116 and molecular oxygen out of cathode catalyst layer 116. Graphyne-based layers 112 and 114 are also configured to reduce or prevent transport of catalyst material (e.g., Pt²⁺ catalyst material as shown in FIG. 3B) out of cathode catalyst layer 116. Graphyne-based layers 112 and 114 are configured to suppress crossover gases (e.g., hydrogen into cathode catalyst layer 116 and molecular oxygen out of cathode catalyst layer 116). This suppression of crossover gases may improve performance and efficiency of the MEA. Moreover, the suppression may decrease degradation of the MEA by hindering degradation reactants (e.g., O₂ to the anode for peroxide formation and/or H₂ to the cathode for reducing cationic Pt).

In one or more embodiments, an electrochemical cell including a membrane electrode assembly (MEA) is disclosed. The MEA includes an anode catalyst layer, a cathode catalyst layer, and an electrolyte membrane layer extending between the anode catalyst layer and the cathode catalyst layer. A graphyne-based layer may be disposed between the cathode catalyst layer and the electrolyte membrane layer and/or the anode catalyst layer and the electrolyte membrane layer. The graphyne-based layer may be separate and discrete from the anode catalyst layer, the cathode catalyst layer, and the electrolyte membrane layer such that the contents of the graphyne-based layer does not commingle with the contents of the anode catalyst layer, the cathode catalyst layer, or the electrolyte layer upon fabrication of the MEA of the electrochemical cell. In other embodiments, there may be commingling between the contents of the graphyne-based layer and the contents of the anode catalyst layer, the cathode catalyst layer, and/or the electrolyte layer upon fabrication of the MEA of the electrochemical cell. In one or more embodiments, the cathode catalyst layer may include a graphyne-based layer (e.g., a graphdiyne-based material with atomically dispersed Fe). In one or more embodiments, the cathode catalyst layer may be an N-doped, H-substituted graphdiyne.

The graphyne-based layer may include sublayers of graphyne-based flakes forming a stacked configuration of the sublayers. The sublayers may be bound by an ionomer material configured to maintain the stacked configuration of the sublayers. The graphyne-based flakes may be oriented substantially parallel to each other in the stacked configuration to maximize the tortuosity of gas diffusion through the graphyne-based layer.

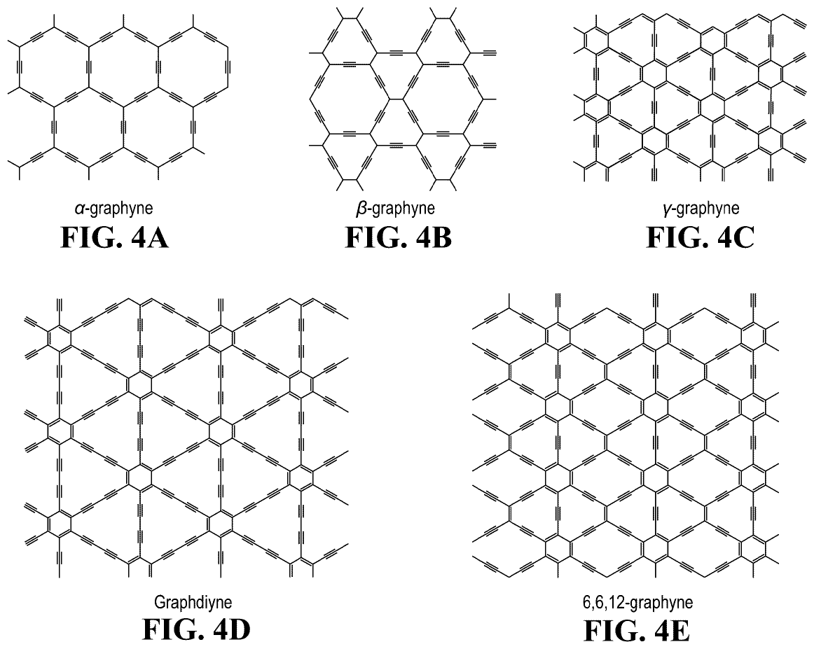

FIGS. 4A through 4E present examples of graphyne-based materials: α-graphyne (FIG. 4A), β-graphyne (FIG. 4B), γ-graphyne (FIG. 4C), graphdiyne (FIG. 4D) and 6,6,12-graphyne (FIG. 4E). In one or more embodiments, graphdiyne may be manufactured using a bulk synthesis method (e.g., copper foil method, diatomite substrate, explosion method, and/or controlled release method) or a thin film synthesis (e.g., about nanometer thickness). Non-limiting examples of thin film analysis include interface between liquids, Si substrate, microwave-induced method, and peeling in aqueous solution of Li₂SiF₆.

The graphyne-based layer may be manufactured via scalable roll-to-roll or spray-coating methods. These fabrication methods may be used to provide a separate and discrete graphyne-based layer. The graphyne-based layer is configured to suppress molecular hydrogen and oxygen crossover. The graphyne-based layer is configured to maintain proton conductivity on an order of Nafion. The graphyne-based layer is configured to suppress diffusion of cationic metal species (e.g., Pt²⁺, Co²⁺, and Ni²⁺).

The following applications are related to the present application: U.S. patent application Ser. No. ______ (RBPA0475PUS), U.S. patent application Ser. No. ______ (RBPA0476PUS), U.S. patent application Ser. No. ______ (RBPA0477PRV), and U.S. patent application Ser. No. ______ (RBPA0479PUS), which are each incorporated by reference in their entirely herein.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A fuel cell comprising:
an anode catalyst layer configured to facilitate an electrochemical reaction converting a gaseous hydrogen atom to a proton and an electron;
a cathode catalyst layer;
an electrolyte membrane layer extending between the anode catalyst layer and the cathode catalyst layer; and
a graphyne-based layer disposed between the cathode catalyst layer and the electrolyte membrane layer or the anode catalyst layer and the electrolyte membrane layer, the graphyne-based layer is configured to suppress crossover gases to enhance performance of the fuel cell.

2. The fuel cell of claim 1, wherein the graphyne-based layer includes sublayers of graphyne-based flakes forming a stacked configuration of the sublayers of the graphyne flakes.

3. The fuel cell of claim 2, wherein the graphyne-based flakes in the graphyne-based sublayers are substantially parallel to each other in the stacked configuration.

4. The fuel cell of claim 2, wherein the sublayers of the graphyne-based flakes are bound by an ionomer material configured to maintain the stacked configuration of the sublayers of the graphyne-based flakes.

5. The fuel cell of claim 4, wherein the ionomer material includes a Nafion ionomer, a Nafion-based material, a polyfluoropolymer, a low equivalent weight ionomer, a high oxygen permeable ionomer (HOPI), or a combination thereof.

6. The fuel cell of claim 1, wherein the graphyne-based layer includes a graphyne-based material and an ionomer material configured to bind the graphyne-based material, a weight ratio of the ionomer material to the graphyne-based material is 1:1 to 1000:1.

7. The fuel cell of claim 1, wherein a thickness of the graphyne-based layer is 0.1 to 5.0 nm.

8. The fuel cell of claim 1, wherein the graphyne-based layer includes a graphyne oxide material or a functionalized graphyne-oxide material.

9. The fuel cell of claim 1, wherein the graphyne-based layer is commingled with the anode catalyst layer or the cathode catalyst layer.

10. The fuel cell of claim 1, wherein the graphyne-based layer is only disposed between the cathode catalyst layer and the electrolyte membrane layer.

11. A fuel cell comprising:
an anode catalyst layer configured to facilitate an electrochemical reaction converting a gaseous hydrogen atom to a proton and an electron;
a cathode catalyst layer;
an electrolyte membrane layer extending between the anode catalyst layer and the cathode catalyst layer; and
a graphyne-based layer disposed between the cathode catalyst layer and the electrolyte membrane layer and/or the anode catalyst layer and the electrolyte membrane layer, the graphyne-based layer is separate and discrete from the anode catalyst layer, the cathode catalyst layer, and the electrolyte membrane layer, the graphyne-based layer is configured to suppress crossover gases to enhance performance of the fuel cell.

12. The fuel cell of claim 11, wherein contents of the graphyne-based layer does not commingle with contents of the anode catalyst layer, the cathode catalyst layer, or the electrolyte membrane layer within the fuel cell.

13. The fuel cell of claim 11, wherein the graphyne-based layer includes sublayers of graphyne-based flakes forming a stacked configuration of the sublayers of the graphyne-based flakes.

14. The fuel cell of claim 13, wherein the graphyne-based flakes in the graphyne-based sublayers are substantially parallel to each other in the stacked configuration.

15. The fuel cell of claim 13, wherein the sublayers of the graphyne-based flakes are bound by an ionomer material configured to maintain the stacked configuration of the sublayers of the graphyne-based flakes.

16. A fuel cell comprising:
an anode catalyst layer configured to facilitate an electrochemical reaction converting a gaseous hydrogen atom to a proton and an electron;
a cathode catalyst layer;
an electrolyte membrane layer extending between the anode catalyst layer and the cathode catalyst layer; and
a graphyne-based layer disposed between the cathode catalyst layer and the electrolyte membrane layer and/or the anode catalyst layer and the electrolyte membrane layer, the graphyne-based layer includes first regions of single layer graphyne flakes and second regions of stacks of multi-layer graphyne flakes, the graphyne-based layer is configured to suppress crossover gases to enhance performance of the fuel cell.

17. The fuel cell of claim 16, wherein the graphyne flakes in the first and second regions are doped graphyne flakes.

18. The fuel cell of claim 16, wherein the graphyne flakes are bound by an ionomer material configured to maintain the first regions of single layer graphyne flakes and the second regions of stacks of multi-layer graphyne flakes.

19. The fuel cell of claim 18, wherein the ionomer material includes a Nafion ionomer, a Nafion-based material, a polyfluoropolymer, a low equivalent weight ionomer, a high oxygen permeable ionomer (HOPI), or a combination thereof.

20. The fuel cell of claim 16, wherein the graphyne-based layer includes a graphyne-based material and an ionomer material configured to bind the graphyne-based material, a weight ratio of the ionomer material to the graphyne-based material is 1:1 to 1000:1.
